(19) United States
(12) Patent Application Publication
(10) Pub. No.: US 2025/0201981 A1
(43) Pub. Date: Jun. 19, 2025

(54) End Plate for a Cell Housing of a Battery Cell, Cell Housing and Battery Cell

(71) Applicant: Bayerische Motoren Werke Aktiengesellschaft, Muenchen (DE)

(72) Inventors: Christoph BORN, Muenchen (DE); Simon HAERLE, Muenchen (DE); Felix LAASCH, Muenchen (DE); Alexander UNTERKREUTER, Muenchen (DE); Seokyoon YOO, Muenchen (DE)

(21) Appl. No.: 18/848,993

(22) PCT Filed: Feb. 22, 2023
(86) PCT No.: PCT/EP2023/054461

§ 371 Date: Sep. 20, 2024

(30) Foreign Application Priority Data
Mar. 22, 2022 (DE) 10 2022 106 665.7

(51) Int. Cl. H01M 50/152; H01M 50/107; H01M 50/166

(52) U.S. Cl. CPC H01M 50/152; H01M 50/107; H01M 50/166

(57) ABSTRACT

An end plate for a cell housing of a battery cell includes: a first side and a second side, the second side arranged opposite the first side; a first groove that forms a first circular shape; and a second groove that forms a second circular shape is provided. A first aperture of the first groove or a second aperture of the second groove is on the first side or on the second side; the first groove and the second groove are mechanically coupled together; the first circular shape has a first radius r1; the second circular shape has a second radius r2; the first circular shape and the second circular shape have a common center; and the first radius r1 is at least 0.8 times as large as the second radius r2. A cell housing for a battery cell is further provided, including: a hollow cylinder; and an end plate, the end plate on an end face of the hollow cylinder. A battery cell is further provided, including a cell housing and an energy-storage device.

### BACKGROUND AND SUMMARY

The present disclosure relates to an end plate for a cell housing of a battery cell, to a cell housing, and to a battery cell.

Cylindrical, prismatic and pouch-shaped lithium-ion battery cells are particularly well known in the field of battery cells. In battery cells, an energy-storage device and electrodes connected thereto may have been arranged within a cell housing. Electrical power can be picked up from outside the cell housing via designated electrical connections to the electrodes. The energy-storage device may feature chemical compounds that may result in emissions of gas within the cell housing. Given a high temperature at the same time, a high pressure may arise within the cell housing, as a result of which the risk of uncontrolled destruction of the battery cell increases. In order to avoid this, a predetermined breaking-point may have been provided in the cell housing, in particular in an end plate of the cell housing, which breaks at or above a previously determined minimal pressure so that the gas can escape and the gas pressure within the cell housing cannot increase any further. It has turned out that a demand for a small tolerance of a triggering pressure that results in the breaking of the predetermined breaking-point requires an elaborate production of the end plate, since a wall thickness of the predetermined breaking-point has to be manufactured correspondingly with a small tolerance.

The object underlying the present disclosure is to make available an end plate for a cell housing of a battery cell having a predetermined breaking-point, which can be manufactured easily and in which a requisite small tolerance of a triggering pressure can be obtained in the installed state.

This object is achieved in accordance with the teaching of the independent claims. Various embodiments and developments of the present disclosure are subjects of the dependent claims.

A first aspect of the present disclosure relates to an end plate for a cell housing of a battery cell, including: (i) a first side and a second side which is arranged opposite the first side; (ii) a first groove which forms a first circular shape; (iii) a second groove which forms a second circular shape; (iv) wherein an aperture of the first groove or another aperture of the second groove has been formed on the first side or on the second side; (v) wherein the first groove and the second groove are mechanically coupled with one another.

The terms—used where appropriate herein—“encompasses”, “includes”, “encloses”, “exhibits”, “has”, “with”, “comprising,” or any other variant thereof, are intended to cover a non-exclusive inclusion. For instance, a method or a device that encompasses or exhibits a list of elements is not necessarily limited to these elements but may include other elements that have not been specified expressly or that are inherent in such a method or in such a device.

Furthermore, unless the contrary has been stated expressly, “or” refers to an inclusive “or” and not to an exclusive “or”. For example, a condition “A or B” is satisfied by one of the following conditions: A is true (or present) and B is false (or not present), A is false (or not present) and B is true (or present), and both A and B are true (or present).

The terms “a” or “an” as used herein are defined in the sense of “one or more”. The terms “another” and “a further”, and also any other variant thereof, are to be understood in the sense of “at least one further one”.

The term “plurality” as used herein is to be understood in the sense of “two or more”.

By the term “configured” or “set up”, to fulfil a particular function, (and by respective modifications thereof), it is to be understood, within the meaning of the present disclosure, that the corresponding device is already present in a configuration or setting in which it is able to perform the function or is at least capable of being set—that is to say, capable of being configured—in such a way that it is able to perform the function after appropriate adjustment. The configuration may be undertaken, for instance, via an appropriate setting of parameters of a process sequence or of switches, or similar, for activating or deactivating functionalities or settings. In particular, the device may exhibit several predetermined configurations or operating modes, so that the configuring can be undertaken by a selection of one of these configurations or operating modes.

By virtue of the end plate according to the first aspect, it can be ensured that the first groove and the second groove act as a common predetermined breaking-point. In the assembled state of the end plate on a cell housing of a battery cell this may be advantageous. In this case, an energy-storage device by which gases may be emitted may be arranged in the interior of the cell housing which may have been sealed in gas-tight manner. If the gas pressure in the interior of the cell housing increases, a risk of uncontrolled bursting of the cell housing of the battery cell may arise. In order to avoid this, a predetermined breaking-point may have been provided on the end plate, which breaks at a previously established gas pressure so that gas can escape from the cell housing and the gas pressure in the cell housing cannot rise any further. According to the present solution with two grooves mechanically coupled with one another, in the event of a rising gas pressure in the cell housing a deformation or “kinking” of the groove that has a smaller radius of the circular shapes may occur, as a result of which an aperture angle of this groove grows larger. This may have the consequence that in the other one of the two grooves, having the larger radius, only a tensile stress acts that results in a tapering and ultimately in the breaking of the material and an opening of the cell housing at the end plate. By virtue of this mechanical coupling, a break of the predetermined breaking-point can occur at a lower gas pressure, compared with a predetermined breaking-point that has been formed by a single groove. As a result, in the case of manufacture according to the present solution, with two grooves in comparison with one groove, a larger residual base thickness may have been provided, which to a thickness of the end plate between a base region of a groove and the remaining material toward the corresponding side of the end plate, in order to bring about breaking at the predetermined breaking-point at a specified pressure. As a result, a higher tolerance in the course of manufacture of the individual grooves can be made possible. By virtue of the formation of the first groove and of the second groove as circular shapes, easy manufacture can be achieved as well. Overall, therefore, production of the end plate having the two grooves can be simplified by the present disclosure. Moreover, a higher mechanical stability of the end plate overall can be obtained by virtue of a larger residual base thickness of the grooves. In addition, it would be conceivable that through the use of two grooves a lower minimal pressure at which breaking of the end plate occurs can be stipulated.

In the following, preferred embodiments of the end plate will be described, which—unless this is expressly excluded or is technically impossible—can in each instance be combined arbitrarily with one another and also with the further, other aspects of the present disclosure that have been described.

In some embodiments, (i) the first circular shape of the first groove has a first radius; (ii) the second circular shape of the second groove has a second radius; (iii) the first circular shape and the second circular shape having a common center, and the first radius (r1) being at least 0.8 times as large as the second radius (r2). This can be expressed mathematically as follows: r1≥0.8·r2. As a result, it can be ensured that a relative spacing between the first groove and the second groove is not exceeded, as a result of which a minimal strength of the mechanical coupling between the first groove and the second groove is obtained.

In some embodiments, the one aperture of the first groove and the other aperture of the second groove are each arranged on the first side or each arranged on the second side. By virtue of the fact that the apertures of the first groove and of the second groove are arranged on the same side of the end plate, easier manufacture of the end plate and therefore of the cell housing can be made possible, since the end plate only has to be machined from one side.

In some embodiments, the one aperture of the first groove is arranged on the first side, and the other aperture of the second groove is arranged on the second side. By this means, a greater rigidity of the end plate can be obtained by virtue of the asymmetrical arrangement. This may be advantageous with respect to external mechanical influences.

In some embodiments, the first groove and/or the second groove have/has a V-shaped cross-section. By virtue of the V-shape, a transfer of force to the other groove can be favored, because the V-shape exhibits an oblique wall that points toward the other groove. Moreover, possible contaminants in the groove region can be removed more easily.

In some embodiments, the first groove and/or the second groove have/has a rectangular cross-section. As a result, easy manufacture is possible, since a tool for forming the groove can have a simple rectangular shape, and the groove exhibits correspondingly straight walls.

In some embodiments, the first circular shape and/or the second circular shape form(s) a circular arc. By virtue of the fact that in the case of a circular arc the circular shape is not closed, it can be ensured that in the event of the end plate breaking at the grooves a broken-out part of the end plate does not fall out or fall into the cell housing, since the part breaking out remains fastened to the end plate at least at the point where the circular shape is not continuous.

In some embodiments, the end plate has a circular shape.

By this means, easy manufacture can be achieved.

A second aspect of the present disclosure relates to a cell housing for a battery cell, including a hollow cylinder and an end plate according to the first aspect, terminating the hollow cylinder at one of its end faces.

A third aspect of the present disclosure relates to a battery cell including a cell housing according to the second aspect and an energy-storage device.

The features and advantages elucidated with respect to the first aspect of the present disclosure also apply correspondingly to the further aspects of the present disclosure.

Further advantages, features and possible applications of the present disclosure will become apparent from the following detailed description in conjunction with the Figures.

### BRIEF DESCRIPTION OF THE DRAWINGS

FIG. 1 shows schematically an end plate in a plan view;

FIG. 2A shows schematically an end plate according to a first embodiment in a side view with a first and with a second V-shaped groove with apertures on the same side;

FIG. 2B shows schematically an end plate according to a second embodiment in a side view with a first and with a second V-shaped groove, with apertures on different sides; and

FIG. 3 shows schematically a battery cell with a cell housing and with an end plate.

Throughout the Figures, the same reference symbols are used for the same elements of the present disclosure or for elements of the present disclosure corresponding to one another.

### DETAILED DESCRIPTION OF THE DRAWINGS

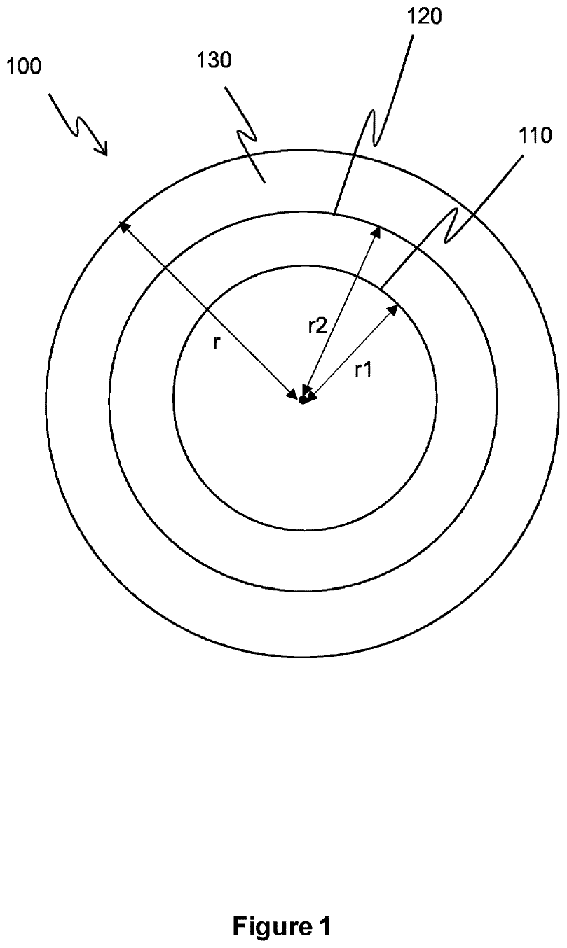

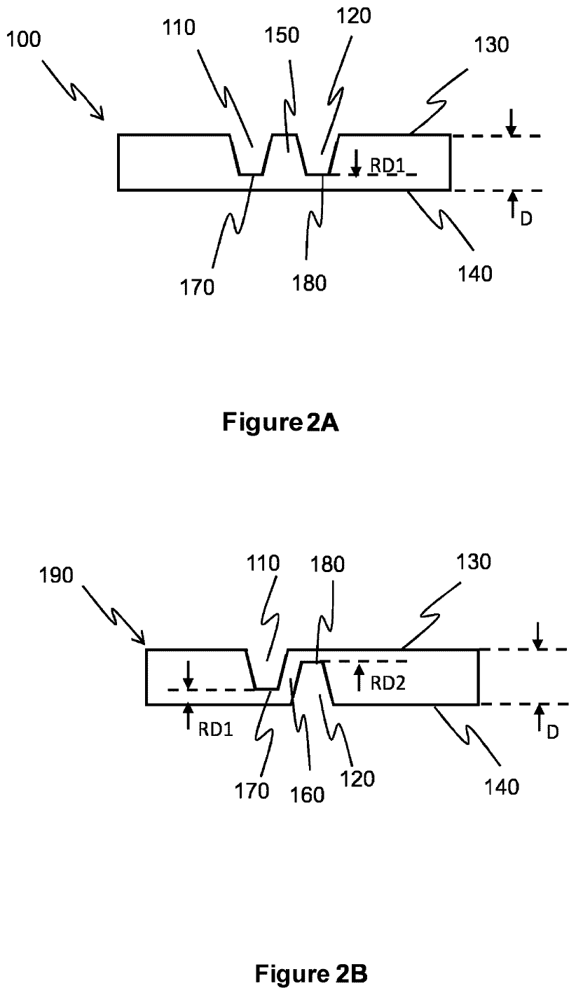

In FIG. 1 a circular end plate 100 according to a first embodiment example according to FIG. 2A is shown schematically in a plan view. The end plate 100 exhibits a first side 130 and a second side 140 (see FIGS. 2A and 2B). The circular end plate 100, and correspondingly the first side 130 and the second side 140, has a radius r. The end plate 100 exhibits a first groove 110 and a second groove 120, which each form a circular shape on the first side 130. The first groove 110 has a first radius r1, and the second groove 120 has a second radius r2, the second radius r2 being larger than the first radius r1. Preferably, r1≥0.8·r2. As a result, it can be ensured that a relative minimal spacing between the first groove 110 and the second groove 120 is not exceeded. As a result, a mechanical interaction between the first groove 110 and the second groove 120 can be obtained when a mechanical force, for instance by virtue of a gas pressure, is exerted on the end plate 100 on the first side 130 or on the second side 140.

In FIG. 2A an end plate 100 according to the present disclosure according to a first embodiment is shown schematically in a side view with a first V-shaped groove 110 and with a second V-shaped groove 120, the apertures of which are arranged on the same side 130 of the end plate 100, which is the first side 130.

The first groove 110 exhibits an aperture, with a first width on a first side 130 of the end plate 100, and a first base region 170 with a second width, the first base region 170 being arranged between the first side 130 and a second side 140 of the end plate 100. The first width is larger than the second width, as a result of which the cross-section of the first groove 110 takes the form of a V-shape. In other words, the cross-section of the first groove 110 tapers from the first side 130 toward the base region 170. The first groove 110 accordingly extends from the aperture of the first side 130 into the end plate 100 in the direction of a second side 140 which is arranged opposite the first side 130 and parallel to the first side 130.

The end plate 100 has a thickness D and, in the region of the first groove 110, a first residual thickness RD1 which extends from the base region of the first groove 110 as far as the second side 140.

The aperture of the second groove 120 has a third width and a second base region 180 with a fourth width, the second base region 180 being arranged between the first side 130 and a second side 140 of the end plate 100. The third width is larger than the fourth width. Correspondingly, the second groove 120 likewise has a V-shaped cross-section. In other words, the cross-section of the second groove 120 tapers from the first side 130 toward base region 180. Between the second base region 180 of the second groove 120 and the second side 140 the end plate 100 has the first residual thickness RD1.

The first groove 110 and the second groove 120 have a cross-section of equal size, the first width being equal to the third width, and the second width being equal to the fourth width. But it is also conceivable that the cross-sections have different sizes, and the first width has a different size than the third width, and/or the second width has a different size than the fourth width. The apertures of the first groove 110 and of the second groove 120 are spaced from one another. A first wall region 150 is arranged between the first groove 110 and the second groove 120. This first wall region 150 extends from the first side 130 into the end plate 100 with increasing wall thickness, the wall thickness on the first side 130 corresponding to a spacing between the apertures of the first groove 110 and of the second groove 120.

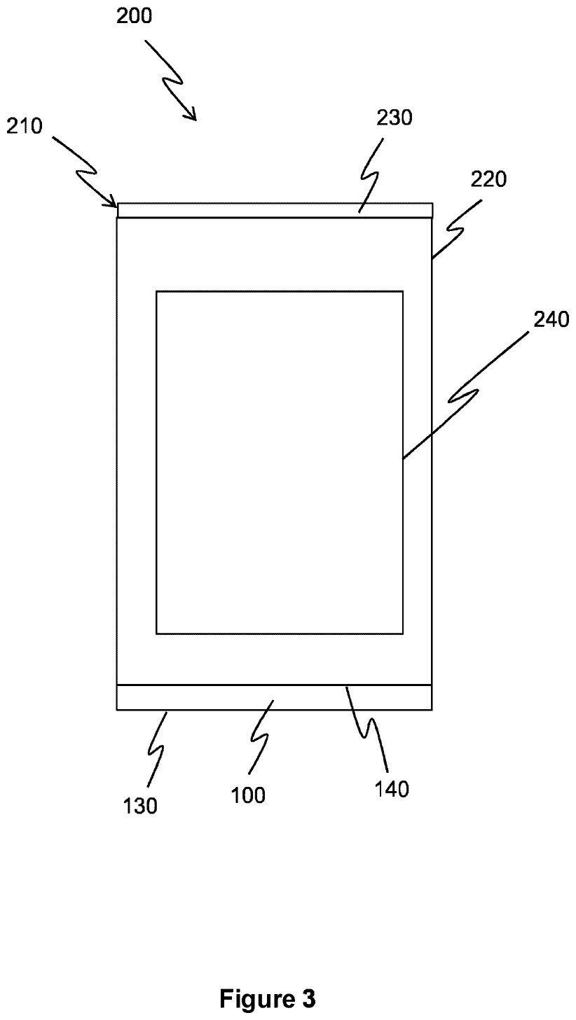

By virtue of this arrangement, the first groove 110 and the second groove 120 are mechanically coupled with one another. By virtue of this mechanical coupling, the first groove 110 and the second groove 120 are able to act as a common predetermined breaking-point. As a result, the end plate 100 is mechanically weakened in its mechanical stability in this region of the predetermined breaking-point. In the event of an application of force to the end plate 100, for instance by virtue of a gas pressure from within a gas-tight cell housing 210 (see FIG. 3) on which the end plate 100 has been mounted, the end plate 100 would firstly break at this predetermined breaking-point, and gas could escape so that an increasing gas pressure in the cell housing 210 cannot increase any further. The aim is that the predetermined breaking-point has been configured in such a way that the predetermined breaking-point breaks at or above a previously established gas pressure. To do this, it is necessary that the two grooves 110, 120 are manufactured within specified manufacturing tolerances, in order to bring about a break of the predetermined breaking-point at a gas pressure that is as close as possible to the previously established gas pressure.

In the event of a rising gas pressure in the cell housing 210, a deformation or “kinking” of the first groove 110 may occur, as a result of which an aperture angle of the first groove 110 grows larger. This may have the consequence that in the second groove 120 only a tensile stress is applied that results in a tapering and ultimately in the breaking of the material and opening of the cell housing at the end plate.

An end plate 100 with two grooves 110, 120 which are mechanically coupled with one another can, in comparison with a single groove, make larger residual base thicknesses RD1, RD2 possible, resulting in greater ease of production. By virtue of the functional separation of “kinking” and “pure tensile stress” on the two grooves 110, 120, larger production tolerances can be made possible for the first residual thickness RD1 and the second residual thickness RD2.

In FIG. 2B an end plate 190 according to a second embodiment is shown schematically in a side view with the first V-shaped groove 110 and with the second V-shaped groove 120, the apertures of which are arranged on different sides 130, 140 of the end plate 190. The aperture of the first groove 110 is arranged on the first side 130, and the aperture of the second groove 120 is arranged on the second side 140. Correspondingly, the first groove 110 extends from its aperture in the direction of the second side 140, and the second groove 120 extends from its aperture in the direction of the first side 130. Between the first base region 170 of the first groove 110 and the second side 140 the end plate 190 has the first residual thickness RD1. Between the second base region 180 of the second groove 120 and the first side 130 the end plate 190 has a second residual thickness RD2. As shown in FIG. 2B, the first groove 110 and the second groove 120 have a cross-section of equal size. Moreover, the first residual thickness RD1 and the second residual thickness RD2 are equal in size, it also being conceivable that they have different sizes. Similarly, according to the embodiment according to FIG. 2B it is also conceivable that the cross-sections have different sizes. A second wall region 160 with a constant wall thickness is arranged between the first groove 110 and the second groove 120, via which a mechanical interaction between the first groove 110 and the second groove 120 can occur.

In FIG. 3 a battery cell 200 with a cell housing 210 and with an end plate 100 according to the first embodiment is shown schematically. The cell housing 210 exhibits a hollow cylinder 220, the end plate 100 according to the first embodiment, with the first side 130 and with the second side, and also a cover 230. The cell housing 210 may equally exhibit an end plate 190 according to the second embodiment. The end plate 100 may take the form of a base plate of the cell housing 210. In the assembled state, the cell housing 210 is designed to be gas-tight. An energy-storage device 240 is arranged within the cell housing 210. As a result of chemical reactions, the energy-storage device 240 is able to generate electric current which can be picked up from outside the cell housing 210. As a result of chemical reactions within the housing, gas may be emitted, and a gas pressure in the interior of the cell housing 210 may rise. By virtue of the end plate 100 according to the present disclosure and the grooves 110, 120 provided, breaking of the end plate 100 can occur at a minimal pressure, and an uncontrolled rise in pressure in the cell housing 210, which may result in uncontrolled destruction of the cell housing 210, can be avoided.

While at least one exemplary embodiment has been described in the foregoing, it is to be noted that there are a large number of variations thereof. It is also to be borne in mind that the exemplary embodiments described represent only non-limiting examples and that it is not intended thereby to limit the scope, the applicability or the configuration of the devices and methods described herein. Rather, the foregoing description will provide a person skilled in the art with instructions for implementing at least one exemplary embodiment, it being understood that various changes in the mode of operation and arrangement of the elements described in an exemplary embodiment may be carried out without deviating from the subject-matter, or its legal equivalents, formulated respectively in the appended claims.

### LIST OF REFERENCE SYMBOLS

100, 190 end plate
110 first groove
120 second groove
130, 140 first and second sides
150, 160 first and second wall regions
170, 180 first and second base regions
200 battery cell
210 cell housing
220 hollow cylinder
230 cover
240 energy-storage device
D thickness of end plate
RD1, RD2 first and second residual thicknesses
r radius of end plate
r1, r2 first and second radii

1-9. (canceled)

10. An end plate for a cell housing of a battery cell, comprising:
a first side and a second side, the second side arranged opposite the first side;
a first groove that forms a first circular shape; and
a second groove that forms a second circular shape;
wherein a first aperture of the first groove or a second aperture of the second groove is on the first side or on the second side;
wherein the first groove and the second groove are mechanically coupled together;
wherein the first circular shape has a first radius r1;
wherein the second circular shape has a second radius r2;
wherein the first circular shape and the second circular shape have a common center; and
wherein the first radius r1 is at least 0.8 times as large as the second radius r2.

11. The end plate according to claim 10, wherein the first aperture of the first groove and the second aperture of the second groove are arranged on the first side or on the second side.

12. The end plate according to claim 10, wherein the first aperture of the first groove is arranged on the first side and the second aperture of the second groove is arranged on the second side.

13. The end plate according to claim 10, wherein the first groove and/or the second groove has a V-shaped cross-section.

14. The end plate according to claim 10, wherein the first groove and/or the second groove has a rectangular cross-section.

15. The end plate according to claim 10, wherein the first circular shape and/or the second circular shape forms a circular arc.

16. The end plate according to claim 10, wherein the end plate has a circular shape.

17. A cell housing for a battery cell, comprising:
a hollow cylinder; and
an end plate according to claim 10, the end plate on an end face of the hollow cylinder.

18. A battery cell comprising a cell housing according to claim 17 and an energy-storage device.
